(19) United States
(12) Patent Application Publication
(10) Pub. No.: US 2015/0299618 A1
(43) Pub. Date: Oct. 22, 2015

(54) CLEANSING COMPOSITION

(71) Applicant: KAO CORPORATION, Chuo-ku, Tokyo (JP)

(72) Inventors: Masaki Shimizu, Shanghai (CN); Wenting Hu, Shanghai (CN)

(73) Assignee: KAO CORPORATION, Chuo-ku, Tokyo (JP)

(21) Appl. No.: 14/439,557

(22) PCT Filed: Nov. 1, 2013
(86) PCT No.: PCT/JP2013/079685

§ 371 Date: Apr. 29, 2015

(30) Foreign Application Priority Data
Nov. 8, 2012 (CN) 201210444122.0

(51) Int. Cl. C11D 1/94; C11D 3/20

(52) U.S. Cl. CPC C11D 1/94; C11D 3/2079; C11D 3/2065

(57) ABSTRACT

A cleansing composition comprising the following components (A), (B), (C), (D) and (E):
(A) a C₁₂₋₂₂ fatty acid or a salt thereof,
(B) an anionic surfactant having a carboxylic acid or a salt thereof in a hydrophilic group, excluding the component (A),
(C) an amphoteric surfactant,
(D) a polyhydric alcohol having an IOB value of 0.8 to 4, or a mixture of a polyhydric alcohol having an IOB value of 0.8 to 4 and a monoalcohol having three or less carbon atoms, and
(E) water;
   wherein
the total content of the component (A) and the component (B), (A)+(B), in terms of acid compounds (by mass) is from 35 to 60% by mass,
the mass ratio of the content of the component (B) to the total content of the component (A) and the component (B), (B)/[(A)+(B)], is from 0.06 to 0.65,
the content of the component (C) is from 1.5 to 15% by mass, and
the content of the component (D) is from 6 to 18% by mass.

### FIELD OF THE INVENTION

The present invention relates to a cleansing composition.

### BACKGROUND OF THE INVENTION

Higher fatty acid salts have been widely used as cleansing agents, because they have excellent foaming properties and sense of use.

Patent Literature 1 describes a skin cleansing composition having improved foaming properties, quality of foam, and the like by adjusting the composition of a fatty acid.

Patent Literature 2 describes a skin cleansing agent having improved storage stability at low and high temperatures, by using a higher fatty acid and a carboxylic acid anionic surfactant in combination with a predetermined amphoteric surfactant and a water-soluble polymer.

### CITATION LIST

### Patent Literature

[Patent Literature 1] JP-A-2005-23069
[Patent Literature 2] JP-A-2011-79743

### SUMMARY OF THE INVENTION

The present invention is directed to a cleansing composition comprising the following components (A), (B), (C), (D) and (E):

(A) a C₁₂₋₂₂ fatty acid or a salt thereof,

(B) an anionic surfactant having a carboxylic acid or a salt thereof in a hydrophilic group, excluding the component (A),

(C) an amphoteric surfactant,

(D) a polyhydric alcohol having an IOB value of 0.8 to 4, or a mixture of a polyhydric alcohol having an IOB value of 0.8 to 4 and a monoalcohol having three or less carbon atoms, and

(E) water;

wherein

the total content of the component (A) and the component (B), (A)+(B), in terms of acid compounds (by mass) is from 35 to 60% by mass,

the mass ratio of the content of the component (B) to the total content of the component (A) and the component (B), (B)/[(A)+(B)], is from 0.06 to 0.65,

the content of the component (C) is from 1.5 to 15% by mass (both inclusive), and

the content of the component (D) is from 6 to 18% by mass.

### DETAILED DESCRIPTION OF THE INVENTION

Various studies have been made as described above; however, Patent Literature 1 is not directed to maintaining low viscosity of a system comprising a surfactant in a high concentration at low temperature, and thus, problems such as viscosity increase of a composition and suppression thereof still remain to be overcome. In Patent Literature 2, excellent storage stability is exhibited at low and high temperatures in the conditions where the concentration of a surfactant is low, and thus, viscosity increase in a system comprising a surfactant in a high concentration at low temperature is a problem which remains unsolved.

Recently, in view of environmental protection and consumer needs such as portability and usability, it has been desired to develop a cleansing composition comprising a surfactant in a high concentration. A cleansing composition comprising a higher fatty acid salt as a surfactant in a high concentration has no precedent and such a cleansing composition having sufficient properties has not yet been obtained at present. One of the reasons for this is considered as follows. If the concentration of a higher fatty acid salt is high, a phase structure called a hexagonal structure, which provides extremely high viscosity, is formed, with the result that it becomes difficult to use such a composition in practice. If the concentration of a surfactant is further increased, a phase structure called a lamella liquid crystal is formed. This is elucidated from scientific studies; however, in this case, viscosity significantly increases by reducing temperature, producing a big problem in practical use. In the circumstances, it has been strongly desired to develop a high-concentration cleansing composition having e.g., satisfactory stability, safety, foaming properties and sense of use, and an appropriate viscosity and capable of overcoming a problem of viscosity increase at low temperature.

As mentioned above, the present invention relates to a provision of a cleansing composition comprising a surfactant in a high concentration, forming a lamella structure providing an appropriate viscosity, suppressing significant increase in viscosity at low temperature and having excellent properties in use such as foaming properties.

The present inventors conducted studies with a view to solving the aforementioned problems. As a result, they found that if a predetermined fatty acid or a salt thereof is used in combination with a predetermined carboxylic acid anionic surfactant, a predetermined amphoteric surfactant, and a polyhydric alcohol having an IOB value of 0.8 to 4 or a mixture of a polyhydric alcohol having an IOB value of 0.8 to 4 and a monoalcohol having three or less carbon atoms in predetermined contents, viscosity increase and crystallization caused by a surfactant contained in a high concentration can be suppressed and low viscosity at low temperature can be ensured, while forming a lamella liquid-crystal structure.

According to the present invention, a significant increase in viscosity at low temperature, which has been a problem caused by increasing the concentration of a surfactant, can be successfully suppressed. More specifically, it is possible to provide a cleansing composition comprising a surfactant serving as a cleansing ingredient in a high concentration, maintaining low viscosity at low temperature, having excellent properties in use such as foaming properties and easily used even in a cold season, although a lamella liquid-crystal structure is formed.

### <Component (A)>

The component (A) to be used in the present invention is a C₁₂₋₂₂ fatty acid or a salt thereof having a linear or branched alkyl group. Particularly, a C₁₂₋₁₄ linear fatty acid or a salt thereof is preferable in view of foaming properties etc. Specific examples thereof include lauric acid, myristic acid, palmitic acid, stearic acid and behenic acid. Lauric acid and myristic acid are more preferable. Examples of commercially available products thereof include PALMAC 98-12 (manufactured by ACIDCHEM) and PALMAC 98-14 (manufactured by ACIDCHEM).

Examples of the salt of the component (A) include alkali metal salts such as a sodium salt and a potassium salt; alkaline-earth metal salts such as a calcium salt and a magnesium salt; ammonium salts; alkanolamine salts such as a monoethanolamine salt, a diethanolamine salt, a triethanolamine salt and an aminomethyl propanol salt; and basic amino acid salts such as a lysine salt and an arginine salt. Of these, an alkali metal salt and a basic amino acid salt are preferable and a potassium salt and an arginine salt are preferable.

As the component (A), one or more selected from lauric acid, myristic acid and salts of these are preferable.

### <Component (B)>

The component (B) to be used in the present invention is an anionic surfactant having a carboxylic acid or a salt thereof in a hydrophilic group, excluding the component (A). More specifically, polyoxyethylene alkyl ether carboxylic acid or a salt thereof and a N-acylamino acid or a salt thereof are preferable.

As the polyoxyethylene alkyl ether carboxylic acid or a salt thereof, a compound represented by the following general formula (1) is preferable.

R—O(CH₂—CH₂O)n-CH₂COOX (1)

wherein, R represents a C₁₀₋₁₈ alkyl group or alkenyl group, n represents a number of 0.5 to 10 in average, and X represents a hydrogen atom, an alkali metal, an alkaline-earth metal, ammonium or an organic ammonium.

In the general formula (1), R is more preferably a C₁₂₋₁₆ alkyl group; the average addition molar number n of ethylene oxides is preferably from 2 to 5; and examples of X include a hydrogen atom; an alkali metal such as sodium and potassium; an alkaline-earth metal such as calcium and magnesium; ammonium; ammonium derived from alkanolamines such as monoethanolamine, diethanolamine and triethanolamine; and ammonium derived from basic amino acids such as arginine and lysine.

Preferable examples of such a polyoxyethylene alkyl ether carboxylic acid or a salt thereof include a sodium, potassium, triethanolamine or arginine salt of polyoxyethylene lauryl ether carboxylic acid, polyoxyethylene myristyl ether carboxylic acid and polyoxyethylene palmityl ether carboxylic acid. In order to effectively suppress viscosity increase and crystallization at low temperature by combination use with the component (A) of the present invention, combination with a polyoxyethylene lauryl ether carboxylic acid and a polyoxyethylene myristyl ether carboxylic acid or a salt of these is preferable. Examples of commercially available products thereof include AKYPO RLM 45CA (manufactured by Kao Corp.) and AKYPO LM 26C (manufactured by Kao Corp.).

As the N-acyl amino acid salt, one having a C₈₋₂₄ acyl group and a carboxylic acid residue is preferable. Specific examples thereof include a N-acyl-β-alanine salt, a N-acyl sarcosinate, a N-acyl glycine salt, a N-acyl glutamate, a N-acyl-L-alanine salt and a N-acyl aspartate. Of these, an arginine salt, potassium salt, triethanolamine salt or sodium salt of N-acyl glycine, is preferable.

As the component (B), a polyoxyethylene alkyl ether carboxylic acid or a salt thereof is preferable.

In the present invention, as the component (A), one or a combination of two or more selected from the above can be used. Also as the component (B), one or a combination of two or more selected from the above can be used. Viscosity increase and crystallization caused by a surfactant contained in a high concentration are suppressed by using the component (A) in combination with the component (B). In view of this, the total content of the component (A) and the component (B) is 35% by mass or more, preferably 40% by mass or more; and 60% by mass or less and preferably 55% by mass or less.

The neutralization rates of the component (A) and the component (B) in a formulation is preferably from 85 to 110% and more preferably from 95 to 105% in order to suppress viscosity increase and crystallization at low temperature.

Furthermore, with respect to the component (A) and the component (B), the mass ratio of the content of the component (B) to the total content of the component (A) and the component (B), (B)/[(A)+(B)], is 0.06 or more and preferably 0.1 or more in order to suppress viscosity increase at low temperature, and more preferably 0.27 or more in order to also maintain flowability at low temperature. Also, (B)/[(A)+(B)] is 0.65 or less and preferably 0.45 or less in order to also maintain flowability at low temperature. Note that the contents of the component (A) and the component (B) are expressed in terms of acid compounds (by mass). The “flowability” refers to the properties such that the sample stored in a glass bottle flows when the bottle is inclined or slightly tapped.

The anionic surfactant serving as the component (B) to be used in the cleansing composition of the present invention and having a carboxylic acid or a salt thereof in the hydrophilic group has an alkyl group as a hydrophobic moiety and a carboxylic acid as a hydrophilic moiety. Because of this, the anionic surfactant resembles the fatty acid serving as the component (A) in structure and thus it is considered that the component (A) and the component (B) are easily and homogeneously mixed even in low-temperature conditions where the mobility of molecules decreases. However, the component (B) has high mobility since it has a linkage group (alkylene oxide etc.) between the alkyl group and the carbonyl group. If a C₁₂₋₂₂ fatty acid serving as the component (A) is used in combination with the component (B), the component (A) is not easily crystallized. As a result, significant increase in viscosity at low temperature would not occur. In particularly excellent case, it is considered that transparency and flowability can be maintained. In contrast, it is considered that anionic surfactants such as a phosphoric acid type, a sulfuric acid type and a sulfonic acid type are not easily and homogeneously mixed with the component (A) in low-temperature conditions where the mobility of the molecules decreases, with the result that crystallization cannot be sufficiently suppressed and a significant increase in viscosity at low temperature conceivably occurs.

### <Component (C)>

The component (C) to be used in the present invention is an amphoteric surfactant.

Examples of such an amphoteric surfactant include alkyl betaines such as palm oil alkyldimethylaminoacetic acid betaine and lauryldimethylaminoacetic acid betaine; amidopropyl betaines such as palm oil fatty acid amidopropyl dimethylaminoacetic acid betaine and lauric acid amidopropyl dimethylaminoacetic acid betaine; sulfobetaines such as lauryl dimethylamino hydroxy propyl sulfobetaine and myristyl dimethylamino hydroxypropyl sulfobetaine; and imidazolinium betaines such as palm oil alkyl-N-carboxymethyl-N-hydroxyethyl imidazolinium betaine and palm oil alkyl-N-carboxyethyl-N-hydroxyethyl imidazolinium betaine. Further, alkyl dimethylamine oxides such as lauryl dimethylamine oxide, decyl dimethylamine oxide and octyl dimethylamine oxide are mentioned.

Of these, an amidopropyl betaine and a sulfobetaine are preferable and a sulfobetaine is more preferable.

As the compound of the component (C), one or a combination of two or more selected from the above can be used. The content of the component (C) in the cleansing composition of the present invention is 1.5% by mass or more and more preferably 3% by mass or more; and 15% by mass or less and more preferably 10% by mass or less. It is preferable that the content fall within these ranges, because, if so, a lamella structure can be stably formed and viscosity increase and crystallization at low temperature are suppressed.

### <Component (D)>

The component (D) to be used in the present invention is a polyhydric alcohol having an IOB value of 0.8 to 4, or a mixture of a polyhydric alcohol having an IOB value of 0.8 to 4 and a monoalcohol having three or less carbon atoms.

The IOB value used herein represents a ratio between an inorganic value and an organic value (Inorganic Organic Balance), which is obtained based on an organic conceptual diagram (Atsushi Fujita, prediction of organic compounds and an organic conceptual diagram, Kagaku no Ryoiki, Vol. 11, No. 10 (1957) 719-725) and calculated in accordance with the following expression:

$$IOB value = \frac{Inorganic value}{Organic value}$$

Examples of the polyhydric alcohol having an IOB value of 0.8 to 4 include propylene glycol (IOB: 3.3), isopropylene glycol (IOB: 2.0), dipropylene glycol (IOB: 1.8), 1,3-butylene glycol (IOB: 2.5), diethylene glycol (IOB: 2.75), pentaerythritol (IOB: 4.0) and polypropylene glycol-9 (IOB: 0.8). Of these, C₃₋₆ polyhydric alcohols such as propylene glycol, isopropylene glycol, dipropylene glycol and 1,3-butylene glycol are preferable and propylene glycol, dipropylene glycol and isopropylene glycol are more preferable.

Examples of the monoalcohol having three or less carbon atoms include ethanol, n-propanol and isopropanol. Of these, ethanol is preferable.

In the case of a polyhydric alcohol having an IOB value of 0.8 to 4, as the component (D) to be used in the present invention, the polyhydric alcohol may be used singly or in combination of two or more. In the case of a mixture of a polyhydric alcohol having an IOB value of 0.8 to 4 and a monoalcohol having three or less carbon atoms, one or more of polyhydric alcohols and one or more of monoalcohols can be used as a mixture as the component (D).

The content of the component (D) in the cleansing composition of the present invention is 6% by mass or more, more preferably 8% by mass or more and even more preferably 10% by mass or more; and 18% by mass or less, more preferably 16% by mass or less and even more preferably 14% by mass or less. It is preferable that the content fall within these ranges, because, if so, a lamella structure can be stably formed and viscosity increase and crystallization at low temperature are suppressed.

If the component (D) is a mixture of a polyhydric alcohol having an IOB value of 0.8 to 4 and a monoalcohol having three or less carbon atoms, the content of a monoalcohol having three or less carbon atoms is preferably 10% by mass or less and even more preferably 4% by mass or less, in view of foaming properties.

The total content of the component (A), the component (B) and the component (D) is preferably 45% by mass or more, more preferably 50% by mass or more; and preferably 70% by mass or less and more preferably 65% by mass or less. It is preferable that the total content fall within these ranges because, if so, a lamella structure can be stably formed and viscosity increase and crystallization at low temperature can be suppressed.

### <Component (E)>

The cleansing composition of the present invention comprises water serving as the component (E). In the present invention, the content of water as the component (E) is the sum of the amount of water contained in raw materials and the amount of water to be added as a single component.

In the cleansing composition of the present invention, the content of water as the component (E) is preferably 5% by mass or more, more preferably 10% by mass or more and even more preferably 15% by mass or more; and preferably 40% by mass or less, more preferably 35% by mass or less and even more preferably 30% by mass or less. In view of viscosity, the mass ratio of the total content of the component (A) and the component (B) to the component (E), [(A)+(B)]/(E), is preferably 1.0 or more, more preferably 1.6 or more; and preferably 4.5 or less and more preferably 3.5 or less.

It was found that the cleansing composition of the present invention forms a lamella liquid-crystal structure by blending the above components. The lamella liquid-crystal structure refers to a structure having optical anisotropy. There are various types of lamella liquid-crystal structures such as lamella liquid-crystal structures having e.g., a layer structure and a vesicle structure. In the present invention, the lamella structure is formed at a high surfactant concentration, more specifically at a higher concentration than a concentration at which a hexagonal structure is formed. The viscosity at which the lamella structure is formed can be lowered by roughly a single order of magnitude than that at which a hexagonal structure is formed. Strictly to say, the lamella structure of the present invention includes a structure of an intermediate state (or transition state) between a lamella structure and a hexagonal structure. In the present invention, it is defined that these intermediate structures belong to the lamella structures. These structures can be determined based on characteristics of images observed under a polarizing microscope. For example, the characteristics of the lamella structure and hexagonal structure observed under a polarizing microscope can be found, for example, in the image shown in Langmuir 2004, 20, p 1641 and the image shown in the frontispiece of “Chemistry of Interfacial Chemistry and Application” (Dainippon tosho Co., Ltd., written by Senoo, Tsujii, published in 1995).

The cleansing composition of the present invention can further comprise a nonionic surfactant. Specific examples thereof include a polyoxyalkylene fatty acid ester, a polyoxyalkylene alkyl ether, a polyoxyalkylene (hydrogenated) castor oil, a sucrose fatty acid ester, an alkyl glyceryl ether, a polyglycerin alkyl ether, a polyglycerin fatty acid ester, a glycerin fatty acid ester, a fatty acid alkanolamide, an alkyl glycoside, a sorbitan fatty acid ester, a polyoxyalkylene sorbitan fatty acid ester, a polyoxyalkylene sorbit fatty acid ester and a polyoxyalkylene glycerin fatty acid ester. As an alkyl group constituting such nonionic surfactants, more specifically, as the alkyl group constituting a long-chain alcohol or a long-chain fatty acid, a C₈₋₂₂ alkyl group is mentioned. Specific examples thereof include a lauryl group, a myristyl group, a palmityl group, a stearyl group, a behenyl group, a lauroyl group, a myristoyl group, a palmitoyl group, a stearoyl group and a behenoyl group.

Of these, a nonionic surfactant having at least one branched alkyl group among alkyl groups constituting the nonionic surfactant is preferable. Specific examples of the branched alkyl group include a (2-)ethylhexyl group, an isodecyl group, a (2-)butyldodecyl group, a (2-) heptylundecyl group, a (2-)isoheptylundecyl group, a (2-) isoheptylisoundecyl group, a (2-)dodecylhexyl group, a (2-)octyldodecyl group, an isostearyl group, an octyldodecyl group and a decyl tetradecyl group. A (2-) ethylhexyl group and an isodecyl group are preferably exemplified. Note that the position of a branched chain in an alkyl group is not particularly specified.

Specific examples thereof include branched alkyl polyoxyethylene ethers having a 0₈ alkyl group including a polyoxyethylene isostearyl ether having an average ethylene-oxide addition molar number of 5 to 15, such as a polyoxyethylene (5) isostearyl ether and a polyoxyethylene (15) isostearyl ether, a polyoxyethylene octyl dodecyl ether having an average ethylene-oxide addition molar number of 3 to 25, such as a polyoxyethylene (5) octyl dodecyl ether and a polyoxyethylene (10) octyl dodecyl ether, and a polyoxyethylene decyl tetradecyl ether having an average ethylene-oxide addition molar number of 3 to 25, such as a polyoxyethylene (5) decyl tetradecyl ether and a polyoxyethylene (10) decyl tetradecyl ether; branched fatty acid polyethylene glycol esters having an average ethylene-oxide addition molar number of 3 to 60, such as an isostearic acid polyethylene glycol; branched fatty acid glyceryl esters, such as an isostearic acid glyceryl ester; branched fatty acid polyglyceryl esters, such as an isostearic acid diglyceryl ester, an isostearic acid decaglyceryl ester and a diisostearic acid diglyceryl ester; branched alkyl glyceryl ethers, such as a glycerin mono-2-ethylhexyl ether, an isodecylglyceryl ether and an isostearyl glyceryl ether; polyoxyethylene branched fatty acid glyceryls having an average ethylene-oxide addition molar number of 3 to 60, such as an isostearic acid polyoxyethylene glyceryl; and branched fatty acid polyoxyethylene hydrogenated castor oils having an average ethylene-oxide addition molar number of 3 to 60, such as an isostearic acid polyoxyethylene hydrogenated castor oil. Of these, a branched alkyl glyceryl ether and a branched alkyl polyoxyethylene ether are preferable; a C₈₋₂₂ branched alkyl glyceryl ether is more preferable, and a glycerin mono-2-ethylhexyl ether and an isodecyl glyceryl ether are even more preferable.

When a nonionic surfactant having a branched chain is mixed with the components (A) and (B), since the nonionic surfactant has a branched chain, the interval between alkyl chains of the components (A) and (B) can be broadened. It is therefore considered that such a nonionic surfactant may help suppression of viscosity increase at low temperature.

The nonionic surfactant may be used singly or in combinations of two or more. The content of the nonionic surfactant in the cleansing composition of the present invention is preferably 0.1% by mass or more and more preferably 1% by mass or more; and preferably 10% by mass or less and more preferably 4% by mass or less. It is preferable that the content fall within these ranges, because, if so, a lamella structure can be stably formed, and viscosity increase and crystallization at low temperature are suppressed.

The cleansing composition of the present invention can further comprise a cationic polymer or an amphoteric polymer. The product of the present invention is a concentrated cleansing composition and characterized in that bubbles are quickly formed even if it is used in a small amount. The volume of foam can be further improved by use of these polymers. Such a polymer is not limited as long as it is usually used as a cleansing agent, and for example, cationic polymers and amphoteric polymers described in JP-A-2008-163237 are mentioned. Specific examples thereof include (a) a cationized cellulose, (b) a cationized guar gum, (c) a diallyl quaternary ammonium salt polymer or a diallyl quaternary ammonium salt-acrylic amide copolymer and (d) a methacryloyloxyethyl quaternary ammonium salt-acrylic amide copolymer. Specific examples of the amphoteric polymer include (e) a diallyl quaternary ammonium salt-acrylic acid copolymer, an acrylic acid-diallyl quaternary ammonium salt-acrylic amide copolymer and (f) an acrylic acid-methacrylamidopropyl quaternary ammonium salt-alkyl acrylate copolymer.

### (a) Cationized Cellulose:

The cation-substitution degree in a cationized cellulose is from 0.01 to 1, more specifically, an average value of the cation-substitution degree per anhydroglucose unit is from 0.01 to 1 and preferably from 0.02 to 0.5. The molecular weight of a cationized cellulose is between about 100,000 to 8,000,000.

Examples of commercially available products include Poise C-80H [manufactured by Kao Corp.] and polymer JR-400 (manufactured by Dow Chemical).

### (b) Cationized Guar Gum:

The cation-substitution degree in a cationized guar gum derivative is preferably from 0.01 to 1, and more preferably from 0.02 to 0.5 cation groups are introduced into a sugar unit.

Examples of commercially available products include those manufactured by Rhodia Inc. under a trade name of Jaguar, such as Jaguar C-13C.

### (c) Diallyl Quaternary Ammonium Salt Polymer or Diallyl Quaternary Ammonium Salt-Acrylamide Copolymer:

The molecular weight of a diallyl quaternary ammonium salt polymer preferably falls within the range of about 30,000 to 1,000,000. The molecular weight of a diallyl quaternary ammonium salt-acrylamide copolymer preferably falls within the range of about 30,000 to 2,000,000 and preferably 100,000 to 1,000,000.

Examples of commercially available products include those manufactured by Noveon, Inc. under a trade name of Merquat, such as Merquat 100 (molecular weight: 150,000) and Merquat 550 (molecular weight: 1,600,000).

### (d) Methacryloyloxy Ethyl Quaternary Ammonium Salt-Acrylamide Copolymer:

The molecular weight of a methacryloyloxy ethyl quaternary ammonium salt-acrylamide copolymer preferably falls within the range of about 1,000,000 to Ser. No. 10/000,000 and preferably 2,000,000 to 6,000,000.

Examples of commercially available products include those manufactured by Noveon, Inc. under a trade name of Merquat, such as Merquat 5 (molecular weight: 4,000,000).

(e) Diallyl Quaternary Ammonium Salt-Acrylic Acid Copolymer and Acrylic Acid-Diallyl Quaternary Ammonium Salt-Acrylamide Copolymer:

The molecular weights of a diallyl quaternary ammonium salt-acrylic acid copolymer and an acrylic acid-diallyl quaternary ammonium salt-acrylamide copolymer preferably fall within the range of 100,000 to 3,000,000 and preferably 100,000 to 1,000,000.

Examples of commercially available products include those manufactured by Noveon, Inc. under a trade name of Merquat, such as Merquat 280 (molecular weight: 450,000), Merquat 295 (molecular weight: 190,000) and Merquat plus 3330 (1,500,000) and Merquat plus 3331 (molecular weight: 1,600,000). Note that Merquat 280 and 295 do not comprise an acrylamide.

### (f) Acrylic Acid-Methacryl Amidopropyl Quaternary Ammonium Salt-Alkyl Acrylate Copolymer:

The molecular weight of an acrylic acid-methacryl amidopropyl quaternary ammonium salt-alkyl acrylate copolymer preferably falls within the range of 600,000 to 3,000,000 and preferably 1,000,000 to 2,000,000.

Examples of commercially available products include those manufactured by Noveon, Inc. under a trade name of Merquat, such as Merquat 2001 (molecular weight: 1,200,000).

Of these, (c) a diallyl quaternary ammonium salt-acrylamide copolymer and (e) a diallyl quaternary ammonium salt-acrylic acid copolymer are preferable polymers, Merquat 295, 280 and 550 are more preferable, and Merquat 295 and 280 are even more preferable.

The cationic polymer or amphoteric polymer may be used singly or in combinations of two or more. The content of the cationic polymer or amphoteric polymer in the cleansing composition of the present invention is preferably 0.1% by mass or more and more preferably 0.4% by mass or more; and preferably 4% by mass or less and more preferably 2% by mass or less in order to lower viscosity and improve the volume of foam at low temperature.

The present invention can further comprise a highly polymerized polyethylene glycol having an average molecular weight of 400,000 or more. The product of the present invention is a concentrated cleansing composition and characterized in that bubbles are formed quickly even if the composition is used in a small amount. The volume of foam can be further improved by use of these polymers. Such a highly polymerized polyethylene glycol has an average molecular weight of 400,000 or more and preferably 1,000,000 or more; and 5,000,000 or less and preferably 3,500,000 or less. The molecular weight herein refers to a weight average molecular weight. As a highly polymerized polyethylene glycol, a polyethylene glycol (ALKOX E100, manufactured by MEISEI CHEMICAL WORKS, LTD.) having a molecular weight of about 3,000,000, a polyethylene glycol (ALKOX E240, manufactured by MEISEI CHEMICAL WORKS, LTD.) having a molecular weight of about 5,000,000, a polyethylene glycol (ALKOX E30G, manufactured by MEISEI CHEMICAL WORKS, LTD.) having a molecular weight of about 400,000, etc. can be used. Of these, a highly polymerized polyethylene glycol having a molecular weight of about 3,000,000 is more preferable.

The polyethylene glycol may be used singly or in combinations of two or more. The content thereof in the cleansing composition of the present invention is preferably 0.01% by mass or more and more preferably 0.075% by mass or more; and preferably 0.25% by mass or less and more preferably 0.15% by mass or less, in order to lower viscosity and improve the volume of foam at low temperature.

### <Other Components>

The cleansing composition of the present invention can further comprise the following components usually used in cleansing compositions other than the aforementioned components, if necessary, as long as the effects of the present invention are not damaged. Examples of such components include a viscosity modifier such as an anionic polymer and a nonionic polymer except those used as the aforementioned components; a moisturizer such as a polyol except those used as the component (D); a foam increasing agent such as an amide; a chelating agent such as ethylenediaminetetraacetic acid (EDTA), and a phosphonic acid salt; a preservative such as methylparaben and butylparaben; an active ingredient such as a vitamin and a precursor thereof; an animal and plant extract such as lecithin and gelatin or a derivative thereof; a plant extract; a fine powder of a polymer such as nylon and polyethylene; an anti-inflammatory agent such as dipotassium glycyrrhizinate; a disinfectant and antidandruff agent such as triclosan, trichlorocarbane, Octopirox and zinc pyrithione; an antioxidant such as dibutylhydroxytoluene; and others such as a pearl ingredient, a whitening agent, a UV absorbent, a pH regulator, a pigment and a fragrance.

The cleansing composition of the present invention can be produced by a conventional method. The composition can be produced by blending the components (A) to (D) (the procedure for blending is not particularly limited), heating the mixture up to at least melting points of individual components, stirring the mixture to homogenize it, neutralizing it by adding a base and water as the component (E) and cooling the mixture. A lamella structure is formed by mixing the components (A) to (D) together with water as the component (E) to obtain a product in a semitransparent gel state.

The viscosity of the cleansing composition of the present invention at a low temperature (−5° C.) is preferably 500 Pa·s or less and more preferably 300 Pa·s or less. In order to obtain satisfactory flowability, the viscosity is more preferably 100 Pa·s or less; and preferably 1 Pa·s or more and more preferably 10 Pa·s or more. If the low-temperature viscosity falls within the range, the cleansing composition is easily taken out directly from the container and conveniently used even in a cold season.

The viscosity of the cleansing composition of the present invention at room temperature (30° C.) is preferably 100 Pa·s or less. In order to obtain satisfactory spreadability in foaming, the viscosity is more preferably 50 Pa·s or less. Also, the viscosity is preferably 1 Pa·s or more and more preferably 10 Pa·s or more. If the viscosity at 30° C. falls within the range, the cleansing composition has an appropriate viscosity. The composition is easily taken in hand with rarely running off from the hand and easily spread in foaming.

The cleansing composition of the present invention thus obtained can be used, for example, as skin cleaning agents such as a body wash, a face wash and a hand soap, a shampoo, a dishwashing detergent and a laundry detergent. Of the aforementioned uses, the composition is suitably used particularly as a cleansing composition packed in a container with a pump and the like and usable even in a cold season, since it can maintain low viscosity and flowability at low temperature. Particularly, the cleansing composition of the present invention is suitable for a skin cleaning agent such as a body wash, a face wash and a hand soap.

The present invention relates to a method for washing a body comprising applying the cleansing composition of the present invention as a skin cleaning agent to a body. More specifically, the cleansing composition of the present invention is used in such a manner that the composition is taken out from a container to a hand, diluted with water, sufficiently foamed, applied to skin, spread well on the skin and rinsed away with water.

The present invention relates to use of the cleansing composition of the present invention in washing a body.

In connection with the aforementioned embodiments, the present invention further discloses the following compositions.

<1> A cleansing composition comprising the following components (A), (B), (C), (D) and (E):

(A) a C₁₂₋₂₂ fatty acid or a salt thereof,

(B) an anionic surfactant having a carboxylic acid or a salt thereof in a hydrophilic group, excluding the component (A),

(C) an amphoteric surfactant,

(D) a polyhydric alcohol having an IOB value of 0.8 to 4, or a mixture of a polyhydric alcohol having an IOB value of 0.8 to 4 and a monoalcohol having three or less carbon atoms, and

(E) water;

wherein

the total content of the component (A) and the component (B), (A)+(B), in terms of acid compounds (by mass) is from 35 to 60% by mass,

the mass ratio of the content of the component (B) to the total content of the component (A) and the component (B), (B)/[(A)+(B)], is from 0.06 to 0.65,

the content of the component (C) is from 1.5 to 15% by mass, and

the content of the component (D) is from 6 to 18% by mass.

<2> The cleansing composition according to item <1>, wherein the total content of the component (A) and the component (B), (A)+(B), is preferably from 40 to 55% by mass.

<3> The cleansing composition according to item <1> or <2>, wherein the mass ratio of the content of the component (B) to the total content of the component (A) and the component (B), (B)/[(A)+(B)], is preferably from 0.1 to 0.65 and more preferably from 0.27 to 0.45.

<4> The cleansing composition according to any one of the above items <1> to <3>, wherein the total content of the component (A), the component (B) and the component (D), (A)+(B)+(D), is preferably from 45 to 70% by mass.

<5> The cleansing composition according to any one of the above items <1> to <4>, wherein the mass ratio of the total content of the component (A) and the component (B) to the content of the component (E), [(A)+(B)]/(E), is preferably from 1.0 to 4.5.

<6> The cleansing composition according to any one of the above items <1> to <5>, wherein the viscosity at −5° C. is preferably from 1 Pa·s to 500 Pa·s, more preferably from 10 Pa·s to 300 Pa·s and even more preferably from 10 Pa·s to 100 Pa-s.

<7> The cleansing composition according to any one of the above items <1> to <6>, wherein the viscosity at 30° C. is preferably from 1 Pa·s to 100 Pa·s and more preferably from 10 Pa·s to 50 Pa·s.

<8> The cleansing composition according to any one of the above items <1> to <7>, wherein the C₁₂₋₂₂ fatty acid or a salt thereof as the component (A) is preferably at least one selected from the group consisting of lauric acid, myristic acid and salts of these.

<9> The cleansing composition according to any one of the above items <1> to <8>, wherein the anionic surfactant as the component (B) is preferably a polyoxyethylene alkyl ether carboxylic acid or a salt thereof, or a N-acyl amino acid or a salt thereof, and more preferably a polyoxyethylene alkyl ether carboxylic acid or a salt thereof, represented by the general formula (1):

R—O(CH₂—CH₂O)n-CH₂COOX (1)

wherein, R represents a C₁₀₋₁₈ alkyl group or alkenyl group, n represents a number of 0.5 to 10 in average and X represents a hydrogen atom, an alkali metal, an alkaline-earth metal, ammonium or an organic ammonium.

<10> The cleansing composition according to any one of the above items <1> to <9>, wherein the amphoteric surfactant as the component (C) is preferably an alkyl betaine, an amidopropyl betaine, a sulfobetaine, an imidazolinium betaine and an alkyl dimethylamine oxide; more preferably an amidopropyl betaine and a sulfobetaine; and even more preferably a sulfobetaine.

<11> The cleansing composition according to any one of the above items <1> to <10>, wherein the polyhydric alcohol having an IOB value of 0.8 to 4 and serving as the component (D) is preferably propylene glycol, dipropylene glycol, isopropylene glycol and 1,3-butylene glycol; and more preferably propylene glycol, dipropylene glycol and isopropylene glycol.

<12> The cleansing composition according to any one of the above items <1> to <11>, wherein the monoalcohol having three or less carbon atoms and serving as the component (D) is preferably ethanol.

<13> The cleansing composition according to any one of the above items <1> to <12>, further comprising a nonionic surfactant in an amount of preferably from 0.1 to 10% by mass and more preferably from 1 to 4% by mass.

<14> The cleansing composition according to item <13>, wherein the nonionic surfactant is preferably at least one selected from the group consisting of a branched alkyl glyceryl ether and a branched alkyl polyoxyethylene ether, and more preferably a 0₈₋₂₂ branched alkyl glyceryl ether.

<15> The cleansing composition according to item <13> or <14>, wherein the nonionic surfactant is at least one selected from the group consisting of a glycerin mono-2-ethylhexyl ether, an isodecyl glyceryl ether and a mixture of these.

<16> The cleansing composition according to any one of the above items <1> to <15>, further comprising a cationic polymer or an amphoteric polymer in an amount of preferably from 0.1 to 4% by mass and more preferably from 0.4 to 2% by mass.

<17> The cleansing composition according to any one of the above items <1> to <16>, further comprising a highly polymerized polyethylene glycol having an average molecular weight of from 400,000 to 5,000,000 in an amount of preferably from 0.01 to 0.25% by mass and more preferably from 0.075 to 0.15% by mass.

<18> The cleansing composition according to any one of the above items <1> to <17>, wherein the content of the component (C) is preferably from 3 to 10% by mass, and the content of the component (D) is preferably from 8 to 16% by mass and more preferably from 10 to 14% by mass.

<19> The cleansing composition according to any one of the above items <1> to <18>, wherein the mass ratio of the component (B) to the total content of the component (A) and the component (B), (B)/[(A)+(B)], is preferably from 0.1 to 0.45 and more preferably from 0.27 to 0.45.

<20> The cleansing composition according to any one of the above items <1> to <19>, wherein the total content of the component (A), the component (B) and the component (D), (A)+(B)+(D), is preferably from 50 to 65% by mass.

<21> The cleansing composition according to any one of the above items <1> to <20>, wherein the mass ratio of the total content of the component (A) and the component (B) to the content of the component (E), [(A)+(B)]/(E), is preferably from 1.6 to 3.5.

<22> A method for washing a body comprising applying the cleansing composition according to any one of the above items <1> to <21> to a body.

<23> Use of the cleansing composition according to any one of the above items <1> to <21> in washing a body.

### Examples

Now, the present invention will be more specifically described by way of Examples; however, the present invention is not limited to these Examples.

### Examples 1 to 46 and Comparative Examples 1 to 15

The cleansing compositions were produced in accordance with the formulations shown in Table 1 to Table 11 and viscosity at each of the temperatures, and foaming properties and volume of foam in use were evaluated. Note that the amounts in Tables were each described in terms of active ingredient.

Individual components (the component (A), (B), (C), (D)) shown in Table 1 to Table 11 were dissolved by heating to 80° C. to obtain a homogenized mixture. The mixture was neutralized by adding a base and water as the component (E) and then cooled. To the mixture, if necessary, additives such as ethanol, a polymer and a fragrance were added to obtain cleansing compositions of Examples 1 to 46 and Comparative Examples 1 to 15.

The obtained cleansing compositions were evaluated for room-temperature viscosity (30° C.), low-temperature viscosity (−5° C.), foaming properties and volume of foam. The results are shown in Table 1 to Table 11.

### (1)<Viscosity Measurement>

Measurement conditions for viscosity are as follows:

Viscometer: VISCOMETER TVB-10 (manufactured TOKI SANGYO CO., LTD.)
Rotor No.: selected from T-B to T-F depending upon viscosity

| | |
|---|---|
| T-B | 20 to 160 Pa · s |
| T-C | 160 to 400 Pa · s |
| T-D | 400 to 800 Pa · s |
| T-E | 800 to 2000 Pa · s |
| T-F | 2000 to 4000 Pa · s |

Rotation number of rotor: 5 rounds/minute
Measurement time: 1 minute
Temperature 30° C.: A glass bottle containing a sample was placed in a constant-temperature vessel of 30° C.±1° C. for one hour or more. Immediately upon taking out, measurement was performed.
Temperature −5° C.: A glass bottle containing a sample was placed in a constant-temperature vessel of −5° C.±1° C. for 12 hours or more. Immediately upon taking out, measurement was performed.

Furthermore, a sample having a viscosity of 20 Pa·s or less was measured by type-B viscometer (manufactured by Brookfield). Specifically, a sample was rotated by a rotor S64 at a rotation number of 30 rounds/minute, and viscosity, which was measured one minute after initiation of rotation, was specified as the viscosity of the cleansing composition.

### (2)<Evaluation of Foaming Properties>

Five specialists (panelists) took out each of the cleansing compositions (0.15 g) in hand previously moistened, rubbed the composition by both palms for 10 seconds to form bubbles. Foaming properties were evaluated based on the following (I) 4-stage evaluation criteria. Foaming properties were determined based on the total scores of evaluation and in accordance with (II) 3-stage determination criteria.

(I) 4-stage evaluation criteria:

3: Volume of foam is large.

2: Volume of foam is slightly large.

1: Volume of foam is small.

0: Foam is scarcely seen.

(II) 3-stage determination criteria:

A: Total score: 10 or more.

B: Total score: 5 or more and less than 10.

C: Total score: less than 5.

### (3) Foam Retention Evaluation:

Five specialists (panelists) took out each of the cleansing compositions (0.15 g) in hand, formed bubbles by adding water and washed their faces. The volume of foam was evaluated by the following 4-stage evaluation criteria. More specifically, the volume of foam was evaluated based on Example 27 as a reference in accordance with the following (I) 4-stage evaluation criteria. The volume of foam was determined based on the total scores of evaluation and in accordance with (II) 3-stage determination criteria.

(I) 4-stage evaluation criteria:

Reference: Example 27

3: Volume of foam is larger than the reference.

2: Volume of foam is slightly larger than the reference.

1: Volume of foam is equal to the reference (the same level as in Example 27).

0: Volume of foam is smaller than the reference.

(II) 3-stage determination criteria:

A: Total of scores: 12 to 15.

B: Total of scores: 8 to 11.

C: Total of scores: 0 to 7.

TABLE 1

| | | | | | | | | | | |
|---|---|---|---|---|---|---|---|---|---|---|
| | Exam- | | Exam- | | | | | Comparative | Comparative | Comparative |
| Unit: % by mass | ple 1 | Example 2 | ple 3 | Example 4 | Example 5 | Example 6 | Example 7 | Example 1 | Example 2 | Example 3 |

| | | | | | | | | | | | |
|---|---|---|---|---|---|---|---|---|---|---|---|
| A | Lauric acid *1 | 21 | 20 | 16.5 | 15 | 12.5 | 10.5 | 8.5 | 7.5 | | 22.5 |
| | Myristic acid *2 | 21 | 20 | 16.5 | 15 | 12.5 | 10.5 | 8.5 | 7.5 | | 22.5 |
| B | POE (4.5) monoalkyl | 3 | 5 | 12 | 15 | 20 | 24 | 28 | 30 | 45 | |
| | (C₁₂₋₁₆) ether acetic | | | | | | | | | | |
| | acid *3 | | | | | | | | | | |
| C | Lauryl dimethylamino | 4.5 | 4.5 | 4.5 | 4.5 | 4.5 | 4.5 | 4.5 | 4.5 | 4.5 | 4.5 |
| | hydroxypropyl | | | | | | | | | | |
| | sulfobetaine *5 | | | | | | | | | | |
| D | Dipropylene glycol | 7 | 7 | 7 | 7 | 7 | 7 | 7 | 7 | 7 | 7 |
| | Propylene glycol | 7 | 7 | 7 | 7 | 7 | 7 | 7 | 7 | 7 | 7 |
| | Glycerin mono-2- | 2 | 2 | 2 | 2 | 2 | 2 | 2 | 2 | 2 | 2 |
| | ethylhexyl ether *4 | | | | | | | | | | |
| | L-Arginine *6 | 5 | 5 | 5 | 5 | 5 | 5 | 5 | 5 | 5 | 5 |
| | Potassium hydroxide | 10.0 | 9.6 | 8.9 | 8.1 | 7.3 | 6.7 | 6.1 | 5.5 | 3.5 | 10.5 |
| E | Purified water | 19.5 | 19.9 | 20.6 | 21.4 | 22.2 | 22.8 | 23.4 | 24.0 | 26.0 | 19.0 |

| | | | | | | | | | | |
|---|---|---|---|---|---|---|---|---|---|---|
| Total | 100 | 100 | 100 | 100 | 100 | 100 | 100 | 100 | 100 | 100 |
| A + B (% by mass) | 45 | 45 | 45 | 45 | 45 | 45 | 45 | 45 | — | — |
| A + B + D (% by mass) | 59 | 59 | 59 | 59 | 59 | 59 | 59 | 59 | — | — |
| B/(A + B) | 0.067 | 0.11 | 0.27 | 0.33 | 0.44 | 0.53 | 0.62 | 0.67 | — | — |
| (A + B)/E | 2.3 | 2.3 | 2.2 | 2.1 | 2.0 | 2.0 | 1.9 | 1.9 | — | — |
| Viscosity (Pa · s) at 30° C. | 65 | 50 | 39 | 30 | 10 | 9 | 9 | 6 | 4 | 69 |
| Viscosity (Pa · s) at −5° C. | 490 | 240 | 92 | 57 | 60 | 140 | 320 | 3000 | 3040 | 1730 |
| Foaming properties when | A | A | A | A | A | B | B | B | C | A |
| foamed by hands | | | | | | | | | | |

TABLE 2

| | | | | | Comparative | Comparative | Comparative | Comparative |
|---|---|---|---|---|---|---|---|---|
| Unit: % by mass | | Example 8 | Example 9 | Example 10 | Example 4 | Example 5 | Example 6 | Example 7 |
| A | Lauric acid *1 | 12.5 | 12.5 | 12.5 | 12.5 | 12.5 | 12.5 | 12.5 |
| | Myristic acid *2 | 12.5 | 12.5 | 12.5 | 12.5 | 12.5 | 12.5 | 12.5 |
| B | POE (4.5) monoalkyl (C₁₂₋₁₆) ether acetic acid *3 | 20 | | | | | | |
| | Potassium cocoyl glycinate *7 | | 20 | | | | | |
| | POE (6) monoalkyl (C₁₃) ether acetic acid *8 | | | 20 | | | | |
| | POE (2) monoalkyl ether phosphoric acid *9 | | | | 20 | | | |
| | Sodium cocoyl isethionate *10 | | | | | 20 | | |
| | Sodium alkyl (C₁₄₋₁₇) sulfonate *11 | | | | | | 20 | |
| | Sodium POE (2) monoalkyl (C₁₂₋₁₄) sulfonate *12 | | | | | | | 20 |
| C | Lauryl dimethylamino hydroxypropyl | 4.5 | 4.5 | 4.5 | 4.5 | 4.5 | 4.5 | 4.5 |
| | sulfobetaine *5 | | | | | | | |
| D | Dipropylene glycol | 12 | 12 | 12 | 12 | 12 | 12 | 12 |
| | Glycerin mono-2-ethylhexyl ether *4 | 2 | 2 | 2 | 2 | 2 | 2 | 2 |
| | L-Arginine *6 | 5 | 5 | 5 | 5 | 5 | 5 | 5 |
| | Potassium hydroxide | 7.3 | 5.1 | 7.4 | 9.3 | 5.1 | 5.1 | 5.1 |
| E | Purified water | 24.2 | 26.4 | 24.1 | 22.2 | 26.4 | 26.4 | 26.4 |

| | | | | | | | |
|---|---|---|---|---|---|---|---|
| Total | 100 | 100 | 100 | 100 | 100 | 100 | 100 |
| A + B (% by mass) | 45 | 45 | 45 | — | — | — | — |
| A + B + D (% by mass) | 57 | 57 | 57 | — | — | — | — |
| B/(A + B) | 0.44 | 0.44 | 0.44 | — | — | — | — |
| (A + B)/E | 1.86 | 1.7 | 1.87 | — | — | — | — |
| Viscosity (Pa · s) at 30° C. | 27 | 100 | 12 | 46 | 51 | 67 | 67 |
| Viscosity (Pa · s) at −5° C. | 60 | 140 | 120 | >4000 | >4000 | >4000 | >4000 |

TABLE 3

| Unit: % by mass | | Example 11 | Example 12 | Example 13 | Example 14 | Example 15 |
|---|---|---|---|---|---|---|
| A | Lauric acid *1 | 17 | 15 | 15 | 15 | 30 |
| | Myristic acid *2 | 17 | 15 | 15 | 15 | |
| B | POE (4.5) monoalkyl | 17 | 15 | 15 | 15 | 15 |
| | (C₁₂₋₁₆) ether acetic acid *3 | | | | | |
| C | Lauryl dimethylamino | 1.5 | 4.5 | 10 | | 4.5 |
| | hydroxypropyl sulfobetaine *5 | | | | | |
| | Lauric acid amidopropyl | | | | 4.5 | |
| | dimethylamino | | | | | |
| | acetic acid betaine *13 | | | | | |
| D | Dipropylene glycol | 5 | 5 | 5 | 5 | 7 |
| | Propylene glycol | 5 | 5 | 5 | 5 | 7 |
| | Ethanol | 4 | 4 | 4 | 4 | |
| | Potassium hydroxide | 9.7 | 9.7 | 9.7 | 9.7 | 10.3 |
| E | Purified water | 23.8 | 26.8 | 21.3 | 26.8 | 26.2 |

| | | | | | |
|---|---|---|---|---|---|
| Total | 100 | 100 | 100 | 100 | 100 |
| A+ B (% by mass) | 51 | 45 | 45 | 45 | 45 |
| A+ B + D (% by mass) | 65 | 59 | 59 | 59 | 59 |
| B/(A + B) | 0.33 | 0.33 | 0.33 | 0.33 | 0.33 |
| (A + B)/E | 2.1 | 1.7 | 2.1 | 1.7 | 1.7 |
| Viscosity (Pa · s) at 30° C. | 37 | 22 | 43 | 24 | 23 |
| Viscosity (Pa · s) at −5° C. | 44 | 290 | 120 | 310 | 330 |

TABLE 4

| | | Example | Example | Example | Example | Comparative | Comparative |
|---|---|---|---|---|---|---|---|
| Unit: % by mass | | 16 | 17 | 18 | 19 | Example 8 | Example 9 |
| A | Lauric acid *1 | 15 | 15 | 18.6 | 18.6 | 18.6 | 11.3 |
| | Myristic acid *2 | 15 | 15 | 18.6 | 18.6 | 18.6 | 11.3 |
| B | POE (4.5) monoalkyl (C₁₂₋₁₆) ether acetic acid *3 | 13.2 | 13.2 | 16.4 | 16.4 | 16.4 | 10 |
| C | Lauryl dimethylamino hydroxypropyl sulfobetaine *5 | 4.2 | 4.2 | 4.2 | 4.2 | 4.2 | 4.2 |
| D | Dipropylene glycol | 8 | 16 | 10 | 16 | 20 | 8 |
| | Glycerin mono-2-ethylhexyl ether *4 | 2 | 2 | 2 | 2 | 2 | 2 |
| | Potassium hydroxide | 9.6 | 9.6 | 11.9 | 11.9 | 11.9 | 7.2 |
| E | Purified water | 33 | 25 | 18 | 12 | 8 | 46 |

| | | | | | | |
|---|---|---|---|---|---|---|
| Total | 100 | 100 | 100 | 100 | 100 | 100 |
| A + B (% by mass) | 43.2 | 43.2 | 53.6 | 53.6 | 53.6 | 32.6 |
| A + B + D (% by mass) | 51.2 | 59.2 | 63.6 | 69.6 | 73.6 | 40.6 |
| B/(A + B) | 0.31 | 0.31 | 0.31 | 0.31 | 0.31 | 0.31 |
| (A + B)/E | 1.3 | 1.7 | 3.0 | 4.5 | 6.7 | 0.7 |
| Viscosity (Pa · s) at 30° C. | 32 | 14 | 79 | 8 | 8 | 530 |
| Viscosity (Pa · s) at −5° C. | 400 | 48 | 280 | 200 | 3170 | 1460 |

TABLE 5

| | | Example | Example | Example | Comparative | Comparative | Comparative | Comparative | Comparative |
|---|---|---|---|---|---|---|---|---|---|
| Unit: % by mass | | 20 | 21 | 22 | Example 10 | Example 11 | Example 12 | Example 13 | Example 14 |
| A | Lauric acid *1 | 14 | 18 | 24 | 10 | 22.5 | | 15 | 20 |
| | Myristic acid *2 | 14 | 18 | | 10 | 22.5 | | 15 | |
| B | POE (4.5) monoalkyl (C₁₂₋₁₆) | 14 | 18 | 12 | 10 | | 45 | 15 | 10 |
| | ether acetic acid *3 | | | | | | | | |
| C | Lauryl dimethylamino | 10 | 5 | 3 | 10 | 5 | 5 | | 3 |
| | hydroxypropyl sulfobetaine *5 | | | | | | | | |
| D | Dipropylene glycol | 5 | 5 | 7 | 5 | 5 | 5 | 5 | 7 |
| | Propylene glycol | 5 | 5 | 7 | 5 | 5 | 5 | 5 | 7 |
| | Ethanol | 4 | 4 | | 4 | 4 | 4 | 4 | |
| | Potassium hydroxide | 9.1 | 11.8 | 8.2 | 6.5 | 12.1 | 5.1 | 9.7 | 6.9 |
| | Glycerin mono-2-ethylhexyl | | | 3 | | | | | 3 |
| | ether *4 | | | | | | | | |
| | Sodium POE (2) monoalkyl (C₁₂₋₁₄) | | | 9 | | | | | 15 |
| | sulfonate *12 | | | | | | | | |
| E | Purified water | 24.9 | 15.3 | 26.8 | 39.5 | 23.9 | 30.9 | 31.3 | 28.1 |

| | | | | | | | | |
|---|---|---|---|---|---|---|---|---|
| Total | 100 | 100 | 100 | 100 | 100 | 100 | 100 | 100 |
| A + B (% by mass) | 42 | 54 | 36 | 30 | — | — | 45 | 30 |
| A + B + D (% by mass) | 56 | 68 | 50 | 44 | — | — | 59 | 44 |
| B/(A + B) | 0.33 | 0.33 | 0.33 | 0.33 | — | — | 0.33 | 0.33 |
| (A + B)/E | 1.7 | 3.5 | 1.3 | 0.8 | — | — | 1.4 | 1.1 |
| Viscosity (Pa · s) at 30° C | 42 | 67 | 8 | 580 | 45 | 500 | 630 | 0.5 |
| Viscosity (Pa · s) at −5° C. | 110 | 160 | 7 | 1260 | >4000 | 1860 | 1810 | 370 |
| Foaming properties when | A | A | A | C | A | C | C | A |
| foamed by hands | | | | | | | | |

TABLE 6

| | | | Comparative |
|---|---|---|---|
| Unit: % by mass | | Example 23 | Example 15 |
| A | Lauric acid *1 | 15 | 4 |
| | Myristic acid *2 | 15 | 4 |
| B | POE (4.5) monoalkyl | 15 | 3.5 |
| | (C₁₂₋₁₆) ether acetic acid *3 | | |
| C | Lauryl dimethylamino | 4.5 | 4.5 |
| | hydroxypropyl sulfobetaine *5 | | |
| | Acrylic acid-alkyl | | 0.75 |
| | methacrylate copolymer *14 | | |
| D | Dipropylene glycol | 13 | |
| | Glycerin mono-2-ethylhexyl | 2 | 1.5 |
| | ether *4 | | |
| | Potassium hydroxide | 7.3 | 3.1 |
| E | Purified water | 28.2 | 78.65 |

| | | |
|---|---|---|
| Total | 100 | 100 |
| A+ B (% by mass) | 45 | 11.5 |
| A+ B + D (% by mass) | 58 | — |
| B/(A + B) | 0.33 | 0.30 |
| (A + B)/E | 1.6 | 0.1 |
| Viscosity (Pa · s) at 30° C. | 27 | 25 |
| Viscosity (Pa · s) at −5° C. | 65 | 370 |
| Foaming properties when | A | C |
| foamed by hands | | |

TABLE 7

| Unit: % by mass | | Example 24 | Example 25 | Example 26 |
|---|---|---|---|---|
| A | Lauric acid *1 | 30 | 30 | 30 |
| | Myristic acid *2 | | | |
| B | POE (4.5) monoalkyl | 15 | 15 | 15 |
| | (C₁₂₋₁₆) ether | | | |
| | acetic acid *3 | | | |
| C | Lauryl dimethylamino | 3 | 3 | 3 |
| | hydroxypropyl | | | |
| | sulfobetaine *5 | | | |
| D | Isopropylene glycol | 14 | | |
| | 1,3-Butylene glycol | | 14 | |
| | Polypropylene glycol-9 | | | 14 |
| | Potassium hydroxide | 10.3 | 10.3 | 10.3 |
| | Glycerin mono-2- | 3 | 3 | 3 |
| | ethylhexyl ether *4 | | | |
| E | Purified water | 24.7 | 24.7 | 24.7 |

| | | | |
|---|---|---|---|
| Total | 100 | 100 | 100 |
| A+ B (% by mass) | 45 | 45 | 45 |
| A+ B + D (% by mass) | 59 | 59 | 59 |
| B/(A + B) | 0.33 | 0.33 | 0.33 |
| (A + B)/E | 1.8 | 1.8 | 1.8 |
| Viscosity (Pa · s) at 30° C. | 28 | 16 | 80 |
| Viscosity (Pa · s) at −5° C. | 45 | 150 | 95 |
| Foaming properties when | A | B | B |
| foamed by hands | | | |

TABLE 8

| | | Example | Example | Example | Example | Example | Example | Example | Example | Example |
|---|---|---|---|---|---|---|---|---|---|---|
| Unit: % by mass | | 27 | 28 | 29 | 30 | 31 | 32 | 33 | 34 | 35 |
| A | Lauric acid *1 | 15 | 15 | 15 | 15 | 15 | 15 | 15 | 15 | 15 |
| | Myristic acid *2 | 15 | 15 | 15 | 15 | 15 | 15 | 15 | 15 | 15 |
| B | POE (4.5) monoalkyl (C₁₂₋₁₆) | 15 | 15 | 15 | 15 | 15 | 15 | 15 | 15 | 15 |
| | ether acetic acid *3 | | | | | | | | | |
| C | Lauryl dimethylamino | 4.5 | 4.5 | 4.5 | 4.5 | 4.5 | 4.5 | 4.5 | 4.5 | 4.5 |
| | hydroxypropyl sulfobetaine *5 | | | | | | | | | |
| D | Dipropylene glycol | 7 | 7 | 7 | 7 | 7 | 7 | 7 | 7 | 7 |
| | Propylene glycol | 7 | 7 | 7 | 7 | 7 | 7 | 7 | 7 | 7 |
| | Potassium hydroxide | 9.7 | 9.7 | 9.7 | 9.7 | 9.7 | 9.7 | 9.7 | 9.7 | 9.7 |
| | Glycerin mono-2-ethylhexyl ether *4 | 2 | 2 | 2 | 2 | 2 | 2 | 2 | 2 | 2 |
| | Acrylic acid- | | 4 | 2 | 0.4 | | | | | |
| | diallyldimethylammonium | | | | | | | | | |
| | chloride copolymer *15 | | | | | | | | | |
| | Acrylamide- | | | | | 0.16 | | | | |
| | diallyldimethylammonium | | | | | | | | | |
| | chloride copolymer *16 | | | | | | | | | |
| | Polyethylene glycol | | | | | | 0.25 | 0.15 | 0.075 | 0.015 |
| | (Mw = 2500000) *17 | | | | | | | | | |
| E | Purified water | 24.8 | 20.8 | 22.8 | 24.4 | 24.64 | 24.55 | 24.65 | 24.725 | 24.785 |

| | | | | | | | | | |
|---|---|---|---|---|---|---|---|---|---|
| Total | 100 | 100 | 100 | 100 | 100 | 100 | 100 | 100 | 100 |
| A + B (% by mass) | 45.0 | 45.0 | 45.0 | 45.0 | 45.0 | 45.0 | 45.0 | 45.0 | 45.0 |
| A + B + D (% by mass) | 59.0 | 59.0 | 59.0 | 59.0 | 59.0 | 59.0 | 59.0 | 59.0 | 59.0 |
| B/(A + B) | 0.33 | 0.33 | 0.33 | 0.33 | 0.33 | 0.33 | 0.33 | 0.33 | 0.33 |
| (A + B)/E | 1.81 | 2.16 | 1.97 | 1.84 | 1.82 | 1.82 | 1.82 | 1.82 | 1.81 |
| Viscosity (Pa · s) at 30° C. | 24 | 73 | 34 | 27 | 26 | 22 | 25 | 27 | 28 |
| Viscosity (Pa · s) at −5° C. | 30 | 390 | 275 | 33 | 31 | 110 | 28 | 32 | 36 |
| Volume of foam | Reference | B | A | A | B | B | A | A | B |

TABLE 9

| | | Example | Example | Example |
|---|---|---|---|---|
| Unit: % by mass | | 36 | 37 | 38 |
| A | Lauric acid *1 | 10 | 6.5 | 4.3 |
| | Myristic acid *2 | 10 | 18 | 8.7 |
| | Palmitic acid *18 | 2 | 1.5 | 6.5 |
| | Stearic acid *19 | | | 6.5 |
| B | POE (4.5) monoalkyl | 15.3 | 13.4 | 15.7 |
| | (C₁₂₋₁₆) ether acetic acid *3 | | | |
| C | Lauryl dimethylamino | 4.5 | 4.5 | 4.5 |
| | hydroxypropyl sulfobetaine *5 | | | |
| D | Dipropylene glycol | 6.5 | 6.5 | 6.5 |
| | Propylene glycol | 6.5 | 6.5 | 6.5 |
| | Potassium hydroxide | 6.4 | 7.0 | 6.4 |
| | Glycerin mono-2-ethylhexyl | 2 | 2 | 2 |
| | ether *4 | | | |
| | L-Arginine *6 | 5 | 5 | 5 |
| | Acrylamide- | 0.2 | 0.2 | 0.2 |
| | diallyldimethylammonium | | | |
| | chloride copolymer *16 | | | |
| | Polyethylene glycol | 0.03 | 0.03 | 0.03 |
| | (Mw = 2500000) *17 | | | |
| | Alkyl polyglucoside *20 | 3 | | |
| E | Purified water | 28.57 | 28.87 | 27.17 |

| | | | |
|---|---|---|---|
| Total | 100 | 100 | 100 |
| A+ B (% by mass) | 37.3 | 39.4 | 41.7 |
| A+ B + D (% by mass) | 50.3 | 52.4 | 54.7 |
| B/(A + B) | 0.41 | 0.34 | 0.38 |
| (A + B)/E | 1.31 | 1.36 | 1.53 |
| Viscosity (Pa · s) at 30° C. | 19 | 24 | 30 |
| Viscosity (Pa · s) at −5° C. | 360 | 105 | 150 |

TABLE 10

| | | Example | Example | Example | Example | Example | Example | Example |
|---|---|---|---|---|---|---|---|---|
| Unit: % by mass | | 39 | 40 | 41 | 42 | 43 | 44 | 45 |
| A | Lauric acid *1 | 15 | 15 | 15 | 15 | 15 | 15 | 15 |
| | Myristic acid *2 | 15 | 15 | 15 | 15 | 15 | 15 | 15 |
| B | POE (4.5) monoalkyl (C₁₂₋₁₆) ether acetic acid *3 | 13.2 | 13.2 | 13.2 | 13.2 | 13.2 | 13.2 | 13.2 |
| C | Lauric acid amidopropyl dimethylamino acetic acid betaine | 4.2 | | | | | | |
| | *13 | | | | | | | |
| | Palm oil amidopropyldimethyl aminoacetic acid betaine *21 | | 4.2 | | | | | |
| | Palm oil alkyl-N-carboxymethyl-N-hydroxyethyl | | | 4.2 | | | | |
| | imidazolinium betaine *22 | | | | | | | |
| | Lauryl dimethylamine oxide *23 | | | | 4.2 | | | |
| | Decyl dimethylamine oxide *24 | | | | | 4.2 | | |
| | Octyl dimethylamine oxide *25 | | | | | | 4.2 | |
| | Lauryl dimethylamino acetic acid betaine *26 | | | | | | | 4.2 |
| D | Dipropylene glycol | 16 | 16 | 16 | 16 | 16 | 16 | 16 |
| | Glycerin mono-2-ethylhexyl ether *4 | 2 | 2 | 2 | 2 | 2 | 2 | 2 |
| | Potassium hydroxide | 9.6 | 9.6 | 9.6 | 9.6 | 9.6 | 9.6 | 9.6 |
| E | Purified water | 25 | 25 | 25 | 25 | 25 | 25 | 25 |

| | | | | | | | |
|---|---|---|---|---|---|---|---|
| Total | 100 | 100 | 100 | 100 | 100 | 100 | 100 |
| A + B (% by mass) | 43.2 | 43.2 | 43.2 | 43.2 | 43.2 | 43.2 | 43.2 |
| A + B + D (% by mass) | 59.2 | 59.2 | 59.2 | 59.2 | 59.2 | 59.2 | 59.2 |
| B/(A + B) | 0.31 | 0.31 | 0.31 | 0.31 | 0.31 | 0.31 | 0.31 |
| (A + B)/E | 1.7 | 1.7 | 1.7 | 1.7 | 1.7 | 1.7 | 1.7 |
| Viscosity (Pa · s) at 30° C. | 12 | 13 | 7 | 26 | 22 | 24 | 25 |
| Viscosity (Pa · s) at −5° C. | 51 | 60 | 9 | 34 | 31 | 28 | 30 |

TABLE 11

| Unit: % by mass | | Example 46 |
|---|---|---|
| A | Lauric acid *1 | 12.5 |
| | Myristic acid *2 | 12.5 |
| B | POE (2.6) monoalkyl (C₁₂₋₁₆) ether acetic acid *27 | 20 |
| C | Lauryl dimethylamino hydroxypropyl sulfobetaine *5 | 4.5 |
| D | Dipropylene glycol | 12 |
| | Glycerin mono-2-ethylhexyl ether *4 | 2 |
| | L-Arginine *6 | 5 |
| | Potassium hydroxide | 8.0 |
| E | Purified water | 23.5 |

| | |
|---|---|
| Total | 100 |
| A + B (% by mass) | 45 |
| A + B + D (% by mass) | 57 |
| B/(A + B) | 0.44 |
| (A + B)/E | 1.9 |
| Viscosity (Pa · s) at 30° C. | 40 |
| Viscosity (Pa · s) at −5° C. | 62 |

(Note) Components in Tables 1 to 11 are as follows:

1: PALMAC 98-12 (manufactured by ACIDCHEM)
2: PALMAC 98-14 (manufactured by ACIDCHEM)
3: AKYPO RLM 45CA (manufactured by Kao Corp.)
4: Penetol GE-EH (manufactured by Kao Corp.)
5: AMPHITOL 20 HD (manufactured by Kao Corp.)
6: L-Arginine (manufactured by Ajinomoto Co., Inc.)
7: Amisoft (manufactured by Ajinomoto Co., Inc.)
8: Emulsogen DTC acid (manufactured by Clariant)
9: Estamit ME502 (manufactured by Kao Corp.)
10: Hostapon STCI (manufactured by Clariant)
11: Hostapur SAS93 (manufactured by Clariant)
12: Emal 270S (manufactured by Kao Corp.)
13: AMPHITOL 20 AB (manufactured by Kao Corp.)
14: Carbopol ETD2020 (manufactured by Lubrizol)
15: Merquat 295 (manufactured by NOVEON)
16: Merquat 550 (manufactured by NOVEON)
17: ALKOX E-100 (manufactured by MEISEI CHEMICAL WORKS,

### LTD.)

18: PALMAC 98-16 (manufactured by ACIDCHEM)
19: PALMAC 98-18 (manufactured by ACIDCHEM)
20: AG-10LK (manufactured by Kao Corp.)
21: AMPHITOL 55 AB (manufactured by Kao Corp.)
22: AMPHITOL 20Y-B (manufactured by Kao Corp.)
23: AMPHITOL 20N (manufactured by Kao Corp.)
24: AMPHITOL 10N (manufactured by Kao Corp.)
25: AMPHITOL 08N (manufactured by Kao Corp.)
26: AMPHITOL 20BS (manufactured by Kao Corp.)
27: AKYPO LM-26C (manufactured by Kao Chemicals GmbH)

As clear from Tables 1 to 11, it was demonstrated that all of the cleansing compositions obtained in Examples 1 to 46 are suppressed in viscosity increase at low temperature and have excellent foaming properties. Through the observation by a polarizing microscope, it was also confirmed that a lamella structure is formed.

Also as clear from Tables 1 to 11, in the cases as in Comparative Examples 1 to 15 where the total content of the components (A) and (B), the mass ratio of the component (B) to the total content of the components (A) and (B), the content of the component (C) and the content of the component (D) are outside the range of the present invention, it was demonstrated that a lamella structure having an appropriate viscosity cannot be formed or that viscosity significantly increases at low temperature.

### INDUSTRIAL APPLICABILITY

From the foregoing, although a cleansing composition of the present invention comprises a surfactant in a high concentration in order to form a lamella structure, the composition is suppressed in viscosity increase at low temperature and has excellent properties in use such as foaming properties, and thus can be realized as a commercial product as a cleasning composition usable even in a cold season.

1: A cleansing composition comprising the following components (A), (B), (C), (D) and (E):
(A) a C₁₂₋₂₂ fatty acid or a salt thereof,
(B) an anionic surfactant having a carboxylic acid or a salt thereof in a hydrophilic group, excluding the component (A),
(C) an amphoteric surfactant,
(D) a polyhydric alcohol having an IOB value of 0.8 to 4, or a mixture of a polyhydric alcohol having an IOB value of 0.8 to 4 and a monoalcohol having three or less carbon atoms, and
(E) water;
wherein
the total content of the component (A) and the component (B), (A)+(B), in terms of acid compounds (by mass) is from 35 to 60% by mass,
the mass ratio of the content of the component (B) to the total content of the component (A) and the component (B), (B)/[(A)+(B)], is from 0.06 to 0.65,
the content of the component (C) is from 1.5 to 15% by mass, and
the content of the component (D) is from 6 to 18% by mass.

2-3. (canceled)

4: The cleansing composition according to claim 1, wherein the total content of the component (A), the component (B) and the component (D), (A)+(B)+(D), is from 45 to 70% by mass.

5: The cleansing composition according to claim 1, wherein the mass ratio of the total content of the component (A) and the component (B) to the content of the component (E), [(A)+(B)]/(E), is from 1.0 to 4.5.

6: The cleansing composition according to claim 1, wherein the viscosity of the cleansing composition at −5° C. is from 1 Pa·s to 500 Pa·s.

7: The cleansing composition according to claim 1, wherein the viscosity of the cleansing composition at 30° C. is from 1 Pa·s to 100 Pa·s.

8: The cleansing composition according to claim 1, wherein the C₁₂₋₂₂ fatty acid or a salt thereof as the component (A) is at least one selected from the group consisting of lauric acid, myristic acid and salts thereof.

9: The cleansing composition according to claim 1, wherein the anionic surfactant as the component (B) is at least one selected from the group consisting of a polyoxyethylene alkyl ether carboxylic acid and salts thereof.

10: The cleansing composition according to claim 1, wherein the amphoteric surfactant as the component (C) is at least one selected from the group consisting of an amidopropyl betaine and a sulfobetaine.

11: The cleansing composition according to claim 1, wherein the polyhydric alcohol having an IOB value of 0.8 to 4 in the component (D) is at least one selected from the group consisting of propylene glycol, dipropylene glycol and isopropylene glycol.

12: The cleansing composition according to claim 1, wherein the monoalcohol having three or less carbon atoms in the component (D) is ethanol.

13: The cleansing composition according to claim 1, further comprising a nonionic surfactant in an amount of from 0.1 to 10% by mass.

14: The cleansing composition according to claim 13, wherein the nonionic surfactant is at least one selected from the group consisting of a branched alkyl glyceryl ether and a branched alkyl polyoxyethylene ether.

15. (canceled)

16: The cleansing composition according to claim 1, further comprising a cationic polymer or an amphoteric polymer in an amount of from 0.1 to 4% by mass.

17: The cleansing composition according to claim 1, further comprising a highly polymerized polyethylene glycol having an average molecular weight of 400,000 or more in an amount of from 0.01 to 0.25% by mass.

18-23. (canceled)
